(19) United States
(12) Patent Application Publication
(10) Pub. No.: US 2008/0198066 A1
(43) Pub. Date: Aug. 21, 2008

(54) Apparatus and method for calibrating signal in multi-antenna system

(75) Inventors: Hyun-Il Kang, Hwaseong-si (KR); Byung-Ki Kim, Hwaseong-si (KR); Bo-Joon Kim, Yongin-si (KR)

Correspondence Address: DOCKET CLERK, P.O. DRAWER 800889, DALLAS, TX, 75380, US

(73) Assignee: Samsung Electronics Co., Ltd.

(21) Appl. No.: 12/070,779

(22) Filed: Feb. 21, 2008

(30) Foreign Application Priority Data
Feb. 21, 2007 (KR) 2007-0017333

(51) Int. Cl. G01S 7/40

(52) U.S. Cl. 342/174

(57) ABSTRACT

A calibration apparatus and method for use in a transmitting end of a multi-antenna system. The apparatus comprises at least two antennas, at least two transmitters for transmitting a signal through one of the antennas and transmitting a reference signal for channel estimation of transmission and reception paths, at least two receivers for receiving a signal through one of the antennas and coupling and receiving a reference signal transmitted through one of the antennas except the antenna for receiving the signal, and a calibration section for estimating channels for transmission and reception paths of the transmitters and the receivers using reference signals received by the receivers and calibrating signals to be transmitted through the transmission paths using the estimated channels.

### CROSS-REFERENCE TO RELATED APPLICATION(S) AND CLAIM OF PRIORITY

This application claims the benefit under 35 U.S.C. §119(a) to a Korean patent application filed in the Korean Intellectual Property Office on Feb. 21, 2007 and assigned Serial No. 2007-17333, the entire disclosure of which is hereby incorporated by reference.

### TECHNICAL FIELD OF THE INVENTION

The present invention relates generally to a calibration apparatus and method for use in a multi-antenna system. More particularly, the present invention relates to an apparatus and method for calibrating a transmission signal without an additional device for calibration in the multi-antenna system.

### BACKGROUND OF THE INVENTION

A multi-antenna system transmits data using different independent channels on an antenna-by-antenna basis, thereby increasing the transmission reliability and the transmission rate as compared with a single antenna system without an additional frequency or transmission power assignment.

When a time division duplexing (hereinafter, referred to as TDD) scheme is used in the multi-antenna system, a forward channel and a reverse channel have a reciprocal relation. Accordingly, a transmitting end of the multi-antenna system pre-filters a transmission signal using reverse channel information to improve the performance of a forward link.

However, since circuits configuring transmission and reception paths do not have the reciprocal relation, the reverse channel estimated in the transmitting end of the multi-antenna system is shown to be different from the forward channel. For this reason, when a transmission signal is pre-filtered using the reverse channel estimated in the transmitting end, there occurs a problem that a performance may be deteriorated due to the mismatch of the estimated reverse channel and the forward channel.

The multi-antenna system calibrates channels of the transmission and reception paths to compensate the mismatch of the reverse and forward channels. For example, the transmitting end of the multi-antenna system is configured as illustrated in FIG. 1 to perform calibration.

FIG. 1 illustrates a signal calibration apparatus in a conventional multi-antenna system. Herein, a description will be given under an assumption that a transmitting end of the multi-antenna system has two antennas.

As illustrated in FIG. 1, the transmitting end of the multi-antenna system comprises transmitting sections 100 and 101, receiving sections 110 and 111, switches 120 and 121, couplers 130 and 131, a power combiner 140, and a calibration transceiver 150.

The transmitting sections 100 and 101 and the receiving sections 110 and 111 share one antenna using the switches 120 and 121. For example, the first transmitting section 100 and the first receiving section 110 share a first antenna using the first switch 120. In response to a time division duplexing (TDD) signal, the first switch 120 connects the first transmitting section 100 to the first antenna during a transmission interval, and connects the first receiving section 110 to the first antenna during a reception interval. The second transmitting section 101 and the second receiving section 111 share a second antenna using the second switch 121. The second switch 121 connects the second transmitting section 101 to the second antenna during the transmission interval, and connects the second receiving section 111 to the second antenna during the reception interval.

The transmitting end estimates channels of the transmission and reception paths to perform calibration using the calibration transceiver 150. Here, the transmission paths refer to paths from the transmitting sections 100 and 101 to the switches 120 and 121, the couplers 130 and 131, and the antennas. The reception paths denote paths from the antennas to the couplers 130 and 131, the switches 120 and 121, and the receiving sections 110 and 111.

First, when the channels of the transmission paths are estimated, the transmitting sections 100 and 101 output reference signals for estimating channel states of the transmission paths to the antennas through the switches 120 and 121. The couplers 130 and 131 couple the reference signals generated in the transmitting sections 100 and 101.

The power combiner 140 combines the signals coupled in the first coupler 130 and the second coupler 131 into one signal and then outputs the signal. The calibration transceiver 150 simultaneously estimates the channel of the transmission path of the first transmitting section 100 and the channel of the transmission path of the second transmitting section 101. In order for the calibration transceiver 150 to simultaneously receive the reference signals transmitted from the first transmitting section 100 and the second transmitting section 101, the power combiner 140 combines the signals coupled in the first coupler 130 and the second coupler 131 into the one signal and then outputs the signal.

A calibration receiver 153 of the calibration transceiver 150 estimates the channels of the transmission paths using the reference signals of the first and second transmitting sections 100 and 101 received from the power combiner 140.

Next, when the channels of the reception paths are estimated, a calibration transmitter 151 of the calibration transceiver 150 outputs a reference signal for estimating channel states of the reception paths of the first and second receiving sections 110 and 111.

The power combiner 140 divides and outputs the reference signal provided from the calibration transmitter 151 so that the first and second receiving sections 110 and 111 can receive the reference signal simultaneously.

The couplers 130 and 131 output reference signals received from the power combiner 140 to the first and second receiving sections 110 and 111.

The receiving sections 110 and 111 estimate the channels of the reception paths using the reference signals received from the couplers 130 and 131.

Although not illustrated, the transmitting end further comprises a calibrating section to perform the calibration for the transmission and reception paths using channel information of the transmission paths estimated in the calibration receiver 153 and channel information of the reception paths estimated in the receiving sections 110 and 111.

As described above, the transmitting end of the multi-antenna system estimates the channels of the transmission and reception paths for calibration using the additional calibration transceiver. Accordingly, it has a problem that the transmitting end may increase complexity and cost due to the additional device for calibration.

The calibration receiver of the multi-antenna system estimates channels of a plurality of transmission paths simultaneously by partially using reference signals coupled in the transmission paths. For example, the power combiner 140 of FIG. 1 performs a combination into one signal using a part of the reference signal coupled in the first coupler 130 and a part of the reference signal coupled in the second coupler 131. The calibration receiver 153 estimates the channels of the transmission paths using only a part of the reference signal transmitted from the first transmitting section 100 and a part of the reference signal transmitted from the second transmitting section 101 included in the signal provided from the power combiner 140.

In this case, there is a problem that an estimated channel state may be incorrect since the calibration receiver 153 estimates the channels using only a part of the reference signals transmitted through the transmission paths.

### SUMMARY OF THE INVENTION

To address the above-discussed deficiencies of the prior art, it is a primary object to provide an apparatus and a method for calibrating a transmission signal by estimating channels of transmission and reception paths in a multi-antenna system.

Another aspect of the present invention is to provide an apparatus and a method for acquiring channel information of calibration of transmission and reception paths without using additional transmission and reception paths for calibration in a multi-antenna system.

According to one aspect of the present invention, a calibration apparatus for use in a multi-antenna system comprises at least two antennas, at least two transmitters for transmitting a signal through one of the antennas and transmitting a reference signal for a channel estimation of transmission and reception paths, at least two receivers for receiving a signal through one of the antennas and coupling and receiving a reference signal transmitted through one of the antennas except the antenna for receiving the signal, and a calibrator for estimating channels for transmission and reception paths of the transmitters and the receivers using reference signals received by the receivers and calibrating signals to be transmitted through the transmission paths using the estimated channels.

According to another aspect of the present invention, a calibration method for use in a multi-antenna system comprises transmitting a reference signal for a channel estimation of transmission and reception paths by transmitters for transmitting a signal through one of at least two antennas, coupling a reference signal transmitted through one of the antennas except the antenna for receiving the signal by receivers for receiving a signal through one of the antennas, generating calibration coefficients using channel information of transmission and reception paths of the transmitters and the receivers estimated using reference signals coupled and received in the receivers, and calibrating signals to be transmitted through the transmission paths using the calibration coefficients.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a calibration apparatus in a conventional multi-antenna system;

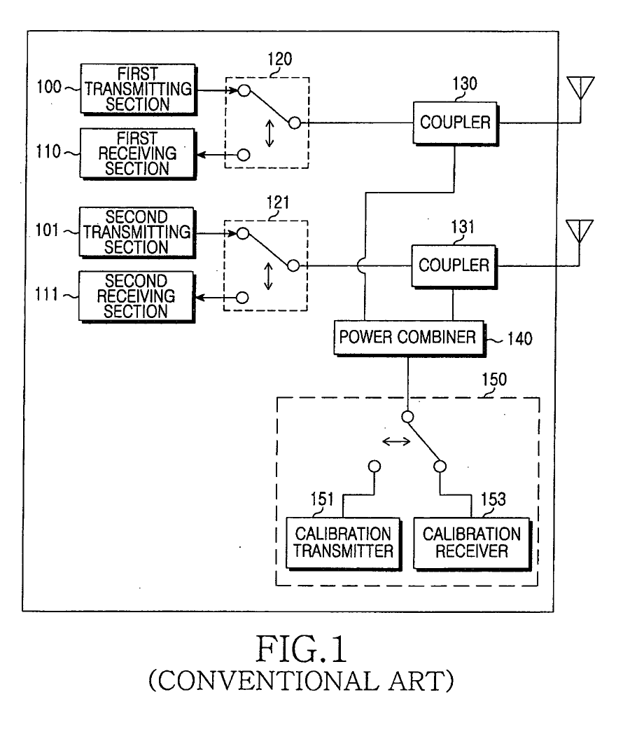

FIG. 2 illustrates a calibration apparatus in a multi-antenna system according to the present invention;

FIG. 3 is a block diagram illustrating a transmitting section in the multi-antenna system according to the present invention;

FIG. 4 is a block diagram illustrating a receiving section in the multi-antenna system according to the present invention;

FIG. 5 is a block diagram illustrating a channel estimating and calibrating section in the multi-antenna system according to the present invention; and

FIG. 6 illustrates a calibration procedure in the multi-antenna system according to an exemplary embodiment of the present invention.

### DETAILED DESCRIPTION OF THE INVENTION

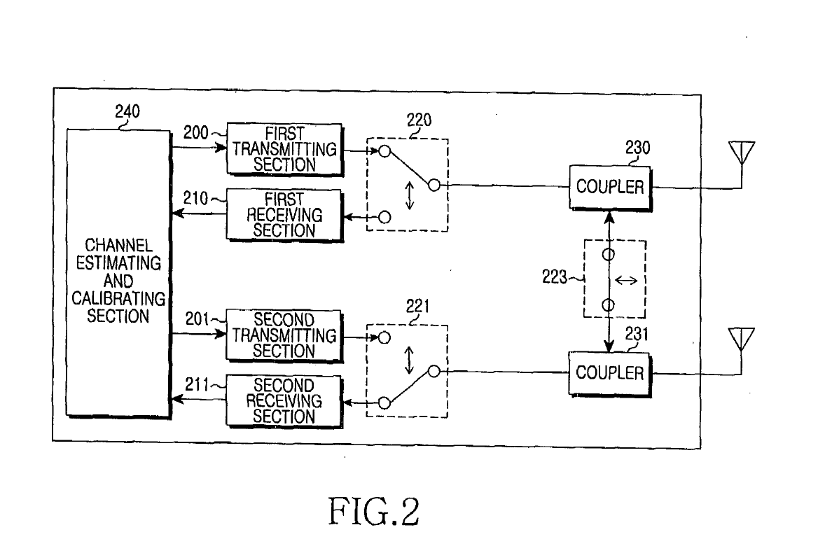

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Hereinafter, a technique for calibrating a transmission signal without using addition transmission and reception paths for calibration in a multi-antenna system will be described.

The following description is given of a multi-antenna system of a time division duplexing (TDD) scheme as an example, but is applicable to multi-antenna systems of other transmission schemes. Moreover, the following description is given under an assumption that a transmitting end has two antennas, but is equally applicable to a transmitting end having multiple antennas.

The transmitting end of the multi-antenna system pre-filters a transmission signal using a reverse channel to improve a performance of a forward link. Here, the reverse channel includes channel information of transmission and reception paths and radio resource channels.

When the transmitting end pre-filters and transmits a transmission signal, a receiving end receives a signal as in Equation 1:

$$\begin{matrix}{y}^{DL} = {H}^{DL} \cdot {F}^{DL} \cdot {x}^{DL} + n \\ = {H}^{DL} \cdot {( {H}^{UL} )}^{- T} \cdot {x}^{DL} + n \\ = ( {D}_{RX . MS} \cdot {H}^{T} \cdot {D}_{TX . BS} ) \cdot ( {D}_{RX . BS}^{- 1} \cdot {H}^{- 1} \cdot {D}_{TX . MS}^{- 1} ) \cdot {x}^{DL} + n\end{matrix} . \qquad [ Eqn . 1 ]$$

Herein, y^{DL} represents a signal received by the receiving end, H^{DL} refers to forward channel information, and F^{DL} denotes a coefficient computed by pre-filtering the transmission signal in the transmitting end. Moreover, x^{DL} represents a signal transmitted from the transmitting end, H^{UL} signifies reverse channel information estimated in the transmitting end, D_{RX.BS} denotes channel information of the reception path of the transmitting end, D_{TX.BS} refers to channel information of the transmission path of the transmitting end, D_{RX.MS} represents channel information of the reception path of the receiving end, D_{TX.MS} denotes channel information of the transmission path of the receiving end, and n represents noise.

The signal transmitted from the transmitting end as shown in Equation 1 is affected by channels of the transmission and reception paths as well as a radio resource channel. Accordingly, the transmitting end performs a calibration for the transmission and reception paths to transmit the signal so that the signal received in the receiving end can be decoded. For example, the transmitting end performs a calibration to set a product of the channels of the transmission and reception paths of the transmitting end to the identity matrix as shown in Equation 2 so that the signal received in the receiving end can be decoded:

$${D}_{TX . BS} \cdot {D}_{RX . BS}^{- 1} = [ \begin{matrix}\frac{{TF}_{TX 1}}{{TF}_{RX 1}} & 0 & 0 & 0 \\ 0 & \frac{{TF}_{TX 2}}{{TF}_{RX 2}} & 0 & 0 \\ ⋮ & ⋮ & ⋮ & ⋮ \\ 0 & 0 & 0 & \frac{{TF}_{{TX}_{Nt}}}{{TF}_{{RX}_{Nt}}}\end{matrix} ] . \qquad [ Eqn . 2 ]$$

Herein, D_{RX.BS} represents channel information of the reception path of the transmitting end, and D_{TX.BS} refers to channel information of the transmission path of the transmitting end. Moreover, TF_{TXi} represents a transfer function of the transmission path corresponding to an i-th antenna of the transmitting end, and TF_{RXi} denotes a transfer function of the reception path corresponding to the i-th antenna of the transmitting end.

In order for the product of the channels for the transmission and reception paths to be set to the identity matrix as shown in Equation 2, transfer function ratios

$$( \frac{{TF}_{Txi}}{{TF}_{RXi}} )$$

for the transmission and reception paths should be identical.

Thus, the transmitting terminal should perform the calibration such that the transfer function ratios for the transmission and reception paths are identical. That is, the transmitting end should perform the calibration so that the transfer function ratios for the transmitting and reception paths can be identical as shown in Equation 3:

$$\frac{{TF}_{TX 1}}{{TF}_{RX 1}} = \frac{{TF}_{TX 2}}{{TF}_{RX 2}} \\ ⇒ {TF}_{TX 1} \cdot {TF}_{RX 2} = {TF}_{TX 2} \cdot {TF}_{RX 1} . \qquad [ Eqn . 3 ]$$

Herein, TF_{TXi} represents a transfer function of the transmission path corresponding to an i-th antenna of the transmitting end, and TF_{RXi} represents a transfer function of the reception path corresponding to the i-th antenna of the transmitting end.

When the transfer function ratios for the transmission and reception paths are identical as shown in Equation 3, a product of transfer functions for the transmission path of the first antenna and the reception path of the second antenna is identical to a product of transfer functions for the reception path of the first antenna and the transmission path of the second antenna.

Thus, the transmitting end performs a control operation such that a reference signal transmitted through the transmission path of the first antenna is received through the reception path of the second antenna as illustrated in FIG. 2 without additional transmission and reception paths for calibration. Moreover, the transmitting end can perform a calibration to make channels of reference signals received through the reception paths be identical by controlling a reference signal transmitted through the transmission path of the second antenna to be received through the reception path of the first antenna.

FIG. 2 illustrates a signal calibration apparatus in the multi-antenna system according to the present invention. Here, reference signal transmission and reception operations between a first transmitting section 200 and a second receiving section 211 are identical to those between a second transmitting section 201 and a first receiving section 210. Therefore, only the reference signal transmission and reception operations between the first transmitting section 200 and the second receiving section 211 will be described below.

As illustrated in FIG. 2, the transmitting end comprises the transmitting sections 200 and 201, the receiving sections 210 and 211, switches 220, 221, and 223, couplers 230 and 231, and a channel estimating and calibrating section 240.

The transmitting sections 200 and 201 and the receiving sections 210 and 211 share one antenna using the switches 220 and 221. For example, in response to a TDD signal, the first switch 220 is switched to connect the first transmitting section 200 to the first antenna during a transmission interval, and is switched to connect the first receiving section 210 to the first antenna during a reception interval. The second switch 221 is switched to connect the second transmitting section 201 to the second antenna during the transmission interval, and is switched to connect the second receiving section 211 to the second antenna during the reception interval.

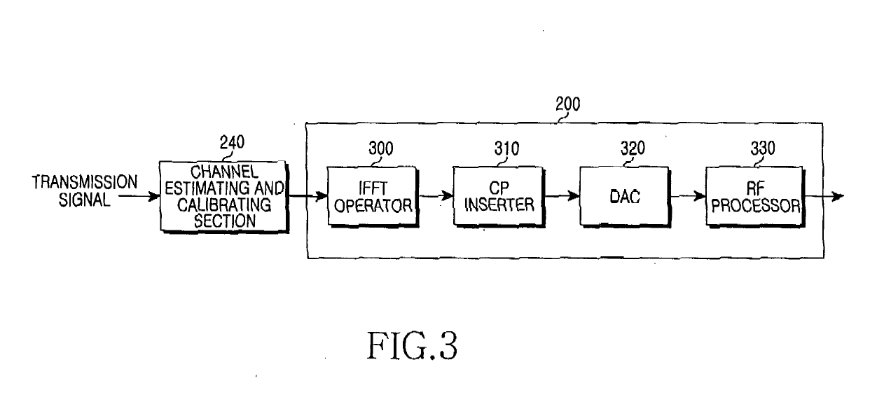

The first transmitting section 200 outputs a reference signal for estimating channels of transmission and reception paths received from the channel estimating and calibrating section 240. For example, the first transmitting section 200 for a signal transmission is configured as illustrated in FIG. 3.

The first coupler 230 couples the reference signal received from the first transmitting section 200 to the second coupler 231.

The third switch 223 switched a connection of the first coupler 230 and the second coupler 231 according to a calibration interval. For example, when the reference signal is transmitted from the first transmitting section 200 for calibration, the third switch 223 connects the first coupler 230 to the second coupler 231. However, when a general traffic signal of non-calibration is transmitted and received, the third switch 223 interrupts the connection of the first coupler 230 and the second coupler 231.

The second coupler 231 provides the reference signal received from the first coupler 230 to the second receiving section 211.

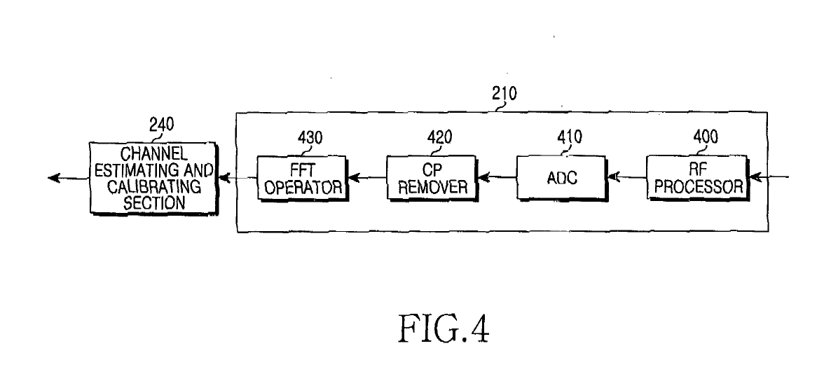

The second receiving section 211 provides the reference signal received from the second coupler 231 to the channel estimating and calibrating section 240. For example, the second receiving section 211 for a signal reception is configured as illustrated in FIG. 4.

The channel estimating and calibrating section 240 estimates channels for the transmission path of the first antenna and the reception path of the second antenna using the reference signal received from the second receiving section 211. Moreover, the channel estimating and calibrating section 240 estimates channels for the transmission path of the second antenna and the reception path of the first antenna using the reference signal received from the first receiving section 210. At this time, the channel estimating and calibrating section 240 estimates products of the channels of the transmission and reception paths.

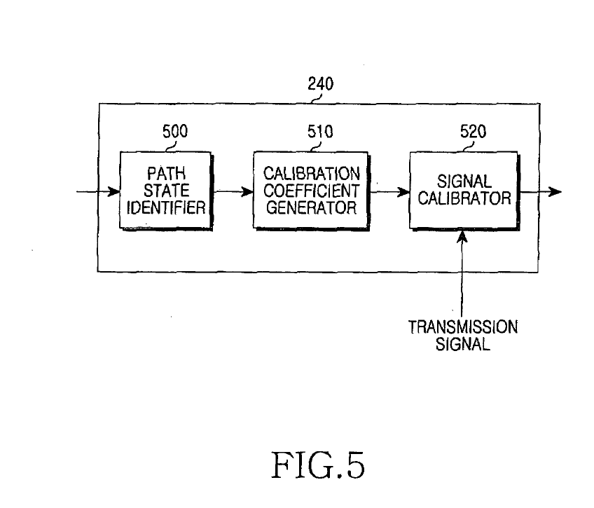

Thereafter, the channel estimating and calibrating section 240 performs a calibration such that the products of the channels for the estimated transmission and reception paths are identical. For example, the channel estimating and calibrating section 240 for a channel estimation and calibration is configured as illustrated in FIG. 5.

FIG. 3 is a block diagram illustrating the transmitting section in the multi-antenna system according to the present invention.

As illustrated in FIG. 3, the transmitting section 200 comprises an inverse fast Fourier transform (IFFT) operator 300, a cyclic prefix (CP) inserter 310, a digital to analog converter (DAC) 320, and a radio frequency (RF) processor 330.

The IFFT operator 300 performs an IFFT operation to transform a reference signal or a transmission signal of a frequency domain received from the channel estimating and calibrating section 240 into a time domain signal. Herein, the IFFT operator 300 is included in an orthogonal frequency division multiplexing (OFDM) modulator for performing the Fourier transform.

To remove an inter-symbol interference due to the multi-path fading effect of a radio channel, the CP inserter 310 inserts a cyclic prefix into a signal received from the IFFT operator 300 and then outputs the signal.

The DAC 320 converts a digital signal received from the CP inserter 310 into an analog signal and then outputs the analog signal.

The RF processor 330 modulates a base-band signal received from the DAC 320 into an RF signal and then outputs the RF signal.

FIG. 4 is a block diagram illustrating the receiving section in the multi-antenna system according to the present invention.

As illustrated in FIG. 4, the receiving section 211 comprises an RF processor 400, an analog to digital converter (ADC) 410, a CP remover 420, and a fast Fourier transform (FFT) operator 430.

The RF processor 400 down-converts an RF signal received from the second coupler 231 into a base-band signal.

The ADC 410 converts an analog signal received from the RF processor 400 into a digital signal and then outputs the digital signal.

The CP remover 420 removes a cyclic prefix (CP) from the signal received from the ADC 410. That is, the CP remover 420 removes, from the signal, the CP inserted by the transmitting section 200 to remove inter-symbol interference.

The FFT operator 430 fast-Fourier-transforms a time domain signal received from the CP remover 420 into a frequency domain signal and then outputs the frequency domain signal to the channel estimating and calibrating section 240. Here, the FFT operator 430 is included in an OFDM demodulator for performing the Fourier transform.

FIG. 5 is a block diagram illustrating the channel estimating and calibrating section in the multi-antenna system according to the present invention.

As illustrated in FIG. 5, the channel estimating and calibrating section 240 comprises a path state identifier 500, a calibration coefficient generator 510, and a signal calibrator 520.

The path state identifier 500 estimates channels of transmission and reception paths through reference signals received from the receiving sections 210 and 211. For example, the path state identifier 500 estimates channels for a transmission path of a first antenna and a reception path of a second antenna using the reference signal received from the second receiving section 211. Moreover, the path state identifier 500 estimates channels for a transmission path of the second antenna and a reception path of the first antenna using the reference signal received from the first receiving section 210. At this time, the path state identifier 500 estimates respective channels for the transmission and reception paths or estimates a product of the channels for the transmission and reception paths.

At this time, each receiving section receives a reference signal from the transmitting section connected to an antenna which is different from another antenna to which the receiving section is connected, and then provide the reference signal to the path state identifier 500. Hence, the path state identifier 500 estimates the channels for the transmission and reception paths using all the reference signals transmitted from the transmitting sections.

The calibration coefficient generator 510 generates calibration coefficients for calibrating signals to be transmitted through the transmitting sections 200 and 201 using channel information of the transmission and reception paths provided from the path state identifier 500. Here, the calibration coefficient indicates a compensation matrix.

For example, the calibration coefficient generator 510 generates the calibration coefficients for transfer function ratios of the transmission and reception paths so that the transfer function ratios of the transmission and reception paths may be identical as shown in Equation 4:

$${D}_{TX . BS} \cdot C \cdot {D}_{RX . BS}^{- 1} = [ \begin{matrix}\frac{{C}_{1} \times {TF}_{TX 1}}{{TF}_{RX 1}} & 0 & 0 & 0 \\ 0 & \frac{{C}_{2} \times {TF}_{TX 2}}{{TF}_{RX 2}} & 0 & 0 \\ ⋮ & ⋮ & ⋮ & ⋮ \\ 0 & 0 & 0 & \frac{{C}_{Nt} \times {TF}_{{TX}_{Nt}}}{{TF}_{{RX}_{Nt}}}\end{matrix} ] . \qquad [ Eqn . 4 ]$$

Herein, D_{RX.BS} represents channel information of the reception path of the transmitting end, D_{TX.BS} refers to channel information of the transmission path of the transmitting end, and C denotes a calibration coefficient. Moreover, TF_{TXi} represents a transfer function of the transmission path corresponding to an i-th antenna of the transmitting end, and TF_{RXi} signifies a transfer function of the reception path corresponding to the i-th antenna of the transmitting end.

In order for the matrix in equation 4 to be an identity matrix, the transfer function ratios for the transmission and reception paths by which calibration coefficients are multiplied should be identical. Thus, the calibration coefficient generator 510 may set transmission and reception paths for one of the antennas as reference paths to generate the calibration coefficients for the transmission and reception paths as shown in Equation 5. Here, the Equation 5 is defined under an assumption that calibration coefficients of the transmission and reception paths for each antenna are generated by setting the transmission and reception paths of the first antenna as reference transmission and reception paths:

$$\begin{matrix}{C}_{1} = 1 \\ {C}_{2} = {C}_{1} \times \frac{{TF}_{TX 1} \times {TF}_{RX 2}}{{TF}_{TX 2} \times {TF}_{RX 1}} \\ ⋮ \\ {C}_{Nt} = {C}_{1} \times \frac{{TF}_{TX 1} \times {TF}_{{RX}_{Nt}}}{{TF}_{{TX}_{Nt}} \times {TF}_{RX 1}}\end{matrix} . \qquad [ Eqn . 5 ]$$

Herein, Cᵢ represents a calibration coefficient for an i-th antenna, TF_{TXi} denotes a transfer function of the transmission path corresponding to the i-th antenna, and TF_{RXi} refers to a transfer function of the reception path corresponding to the i-th antenna.

When the transmission and reception paths of the first antenna are set as reference transmission and reception paths as shown in Equation 5, the transmission paths of the antennas except the first antenna should transmit the reference signals to the reception path of the first antenna. Moreover, the reception paths of the antennas except the first antenna should receive the reference signal from the transmission path of the first antenna.

In this case, the calibration coefficients for the transmission and reception paths of the first antenna are set to 1 since the calibration coefficient generator 510 sets the transmission and reception paths of the first antenna to the reference transmission and reception paths.

The signal calibrator 520 calibrates transmission signals by multiplying signals to be transmitted through respective transmission paths by calibration coefficients for the transmission and reception paths generated in the calibration coefficient generator 510.

As described above, the transmitting end calibrates signals to be transmitted through respective transmission paths using calibration coefficients generated by channel information for respective transmission and reception paths.

When the transmitting end transmits a signal through the calibration, the receiving end receives the signal as shown in Equation 1. At this time, since the signal received in the form of the Equation 1 is the calibrated signal transmitted from the transmitting end, a product of the transmission and reception paths included in the transmitting end is expressed in an identity matrix as shown in Equation 6:

$$\begin{matrix}{D}_{TX . BS} \cdot C \cdot {D}_{RX . BS}^{- 1} = [ \begin{matrix}\frac{{C}_{1} \times {TF}_{TX 1}}{{TF}_{RX 1}} & 0 \\ 0 & \frac{{C}_{2} \times {TF}_{TX 2}}{{TF}_{RX 2}}\end{matrix} ] \\ = [ \begin{matrix}\frac{( 1 ) \times {TF}_{TX 1}}{{TF}_{RX 1}} & 0 \\ 0 & \frac{( \frac{{TF}_{TX 1} \times {TF}_{RX 2}}{{TF}_{TX 2} \times {TF}_{RX 1}} ) \times {TF}_{TX 2}}{{TF}_{RX 2}}\end{matrix} ] . \\ = [ \begin{matrix}\frac{{TF}_{TX 1}}{{TF}_{RX 1}} & 0 \\ 0 & \frac{{TF}_{TX 1}}{{TF}_{RX 1}}\end{matrix} ] = ( \frac{{TF}_{Tx 1}}{{TF}_{RX 1}} ) \cdot I\end{matrix} \qquad [ Eqn . 6 ]$$

Herein, D_{TX.BS} represents channel information of the transmission path of the transmitting end, and D_{RX.MS} signifies channel information of the reception path of the receiving end. In addition, Cᵢ represents a calibration coefficient for an i-th antenna, TF_{TXi} denotes a transfer function of the transmission path corresponding to the i-th antenna, and TF_{RXi} refers to a transfer function of the reception path corresponding to the i-th antenna.

Since a product of channels for the transmission and reception paths has the form of an identity matrix in the calibrated signal transmitted from the transmitting end as shown in Equation 6, the receiving end can decode the signal received from the transmitting end.

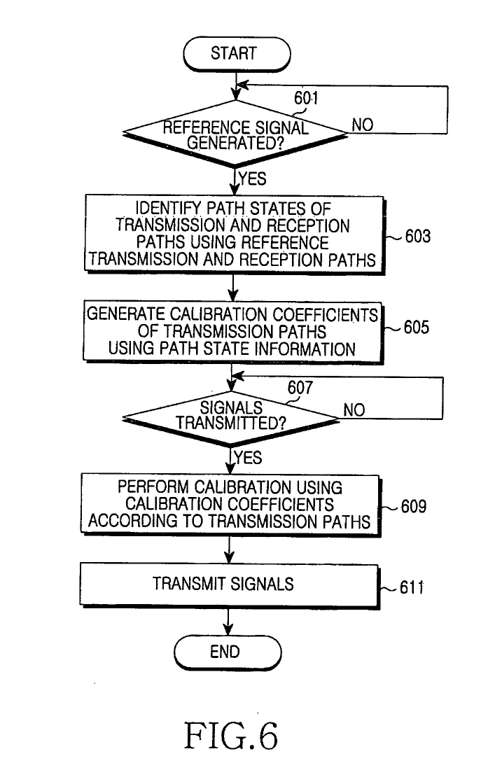

FIG. 6 illustrates a calibration procedure in the multi-antenna system according to an exemplary embodiment of the present invention.

Referring to FIG. 6, the transmitting end determines whether a reference signal is generated to estimate channels of transmission and reception paths connected to respective antennas in step 601.

When the reference signal is generated, the transmitting end proceeds to step 603 to estimate the channels of the transmission and reception paths by transmitting and receiving the reference signal through reference transmission and reception paths. At this time, the transmitting end receives the reference signal transmitted by the reference transmission path, through the remaining reception paths except the reference reception path and estimates the channels. Moreover, the transmitting end receives the reference signals transmitted by the remaining transmission paths except the reference transmission path, through the reference reception path and estimates the channels. For example, as illustrated in FIG. 2, the transmitting end couples a reference signal transmitted through a first transmission path from the first transmitting section 200 to a second reception path and controls the second receiving section 211 to receive the reference signal. Therefore, the channel estimating and calibrating section 240 estimates channels for the first transmission path and the second reception path using the reference signal supplied from the second receiving section 211.

Moreover, the transmitting end couples a reference signal transmitted through a second transmission path from the second transmitting section 201 to a first reception path and controls the first receiving section 210 to receive the reference signal. Hence, the channel estimating and calibrating section 240 estimates channels for the second transmission path and the first reception path using the reference signal received from the first receiving section 210.

After identifying the channels for the transmission and reception paths, the transmitting end proceeds to step 605 to generate calibration coefficients for calibrating signals to be transmitted through respective transmission paths from the transmitting sections. For example, when the first transmitting section 200 and the first receiving section 210 connected to the first antenna are set to reference transmitting and receiving sections, the transmitting end generates the calibration coefficients as shown in the Equation 5.

Thereafter, the transmitting end proceeds to step 607 to determine whether signals are transmitted through the antennas.

When the signals are transmitted, the transmitting end proceeds to step 609 to calibrate signals to be transmitted through respective transmission paths from the transmitting sections using the calibration coefficients generated in step 605.

After the calibration is performed, the transmitting end proceeds to step 611 to transmit the calibrated signals to the receiving end through the antennas connected to respective transmission paths.

Thereafter, the transmitting end completes this algorithm.

Although the present disclosure has been described with an exemplary embodiment, various changes and modifications may be suggested to one skilled in the art. It is intended that the present disclosure encompass such changes and modifications as fall within the scope of the appended claims.

As described above, calibration is performed by connecting respective transmitting and receiving sections without an additional device for calibration in a multi-antenna system, thereby preventing an increase in complexity and cost due to the additional device. Since one receiving section receives a reference signal for one transmitting section and estimates channels of transmission and reception paths, the present disclosure can estimate the channel values of the transmission and reception paths more correctly.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A calibration apparatus for use in a multi-antenna system, comprising:
at least two antennas;
at least two transmitters for transmitting a signal through one of the antennas and transmitting a reference signal for channel estimation of transmission and reception paths;
at least two receivers for receiving a signal through one of the antennas, and coupling and receiving the reference signal transmitted through one of the antennas except the antenna for receiving the signal; and
a calibration section for estimating channels for the transmission and reception paths of the transmitters and the receivers using the reference signals received by the receivers, and calibrating signals to be transmitted through the transmission paths using the estimated channels.

2. The calibration apparatus of claim 1, wherein the transmitters comprise:
an orthogonal frequency division multiplexing (OFDM) modulator for inverse Fourier transforming one of the reference signals or one of the signals calibrated in the calibrator;
a cyclic prefix (CP) inserter for inserting a cyclic prefix into the inverse Fourier transformed signal;
a digital to analog converter for converting the Fourier transformed signal in which the cyclic prefix has been inserted into an analog signal; and
a radio frequency (RF) processor for converting the analog signal into a radio frequency (RF) signal and outputting the RF signal.

3. The calibration apparatus of claim 2, wherein the transmitters further comprise a coupler for coupling the reference signal converted into the RF signal in the RF processor, to the receiver.

4. The calibration apparatus of claim 1, wherein the receivers comprise:
a radio frequency (RF) processor for converting the reference signal transmitted from the transmitter or an RF signal received through an antenna into a base-band analog signal;
an analog to digital converter for converting the base-band analog signal into a digital signal;
a cyclic prefix (CP) remover for removing a cyclic prefix included in the digital signal; and
an orthogonal frequency division, multiplexing (OFDM) demodulator for Fourier-transforming the digital signal from which the cyclic prefix has been removed.

5. The calibration apparatus of claim 4, wherein the receivers further comprise a coupler for coupling reference signals transmitted from the transmitters and providing the reference signals to the RF processor.

6. The calibration apparatus of claim 1, wherein the calibration section comprises:
a path state identifier for estimating the channels of the transmission and reception paths through the reference signals supplied from the receivers;
a calibration coefficient generator for generating calibration coefficients using the channels of the transmission and reception paths; and
a signal calibrator for calibrating the signals to be transmitted through respective transmission paths with the calibration coefficients.

7. The calibration apparatus of claim 1, wherein a transmitter and a receiver connected to one of the antennas are set as a reference transmitter and as a reference receiver for estimating the channels of the transmission and reception paths.

8. The calibration apparatus of claim 7, wherein the reference receiver couples and receives the reference signals transmitted by the transmitters except the reference transmitter.

9. The calibration apparatus of claim 7, wherein the receivers except the reference receiver couple and receive a reference signal transmitted from the reference transmitter.

10. The calibration apparatus of claim 7, wherein the calibration section generates calibration coefficients of the remaining transmission and reception paths on the basis of transfer functions of the reference transmission and reception paths connected to the reference transmitter and the reference receiver and calibration coefficients for the reference transmitter and receiver.

11. The calibration apparatus of claim 10, wherein the calibration section generates calibration coefficients as shown in the following equation:
$$\begin{matrix}{C}_{1} = 1 \\ {C}_{2} = {C}_{1} \times \frac{{TF}_{TX 1} \times {TF}_{RX 2}}{{TF}_{TX 2} \times {TF}_{RX 1}} \\ ⋮ \\ {C}_{Nt} = {C}_{1} \times \frac{{TF}_{TX 1} \times {TF}_{{RX}_{Nt}}}{{TF}_{{TX}_{Nt}} \times {TF}_{RX 1}}\end{matrix}$$
wherein Cᵢ represents a calibration coefficient for an i-th antenna, TF_{TXi} denotes a transfer function of a transmission path corresponding to the i-th antenna, and TF_{RXi} refers to a transfer function of a reception path corresponding to the i-th antenna.

12. A calibration method for use in a multi-antenna system, comprising:
transmitting a reference signal for channel estimation of transmission and reception paths from transmitters for transmitting a signal through one of at least two antennas;
coupling the reference signal transmitted through one of the antennas except the antenna for receiving the signal by receivers for receiving a signal through one of the antennas;
generating calibration coefficients using channel information of the transmission and reception paths of the transmitters and the receivers estimated using reference signals coupled and received in the receivers; and
calibrating signals transmitted through the transmission paths using the calibration coefficients.

13. The calibration method of claim 12, further comprising:
setting a transmitter and a receiver connected to one of the antennas as a reference transmitter and a reference receiver for estimating channels of the transmission and reception paths,
whereby the receivers except the reference receiver couple a reference signal transmitted from the reference transmitter.

14. The calibration method of claim 13, wherein the reference receiver couples reference signals transmitted by the transmitters except the reference transmitter.

15. The calibration method of claim 13, wherein generating the calibration coefficients comprises:
generating calibration coefficients of the remaining transmission and reception paths on the basis of transfer functions of the reference transmission and reception paths connected to the reference transmitter and the reference receiver and calibration coefficients for the reference transmitter and the reference receiver.

16. The calibration method of claim 15, wherein the calibration coefficients are generated by the following equation:
$$\begin{matrix}{C}_{1} = 1 \\ {C}_{2} = {C}_{1} \times \frac{{TF}_{TX 1} \times {TF}_{RX 2}}{{TF}_{TX 2} \times {TF}_{RX 1}} \\ ⋮ \\ {C}_{Nt} = {C}_{1} \times \frac{{TF}_{TX 1} \times {TF}_{{RX}_{Nt}}}{{TF}_{{TX}_{Nt}} \times {TF}_{RX 1}}\end{matrix}$$
wherein Cᵢ represents a calibration coefficient for an i-th antenna, TF_{TXi} denotes a transfer function of a transmission path corresponding to the i-th antenna, and TF_{RXi} refers to a transfer function of a reception path corresponding to the i-th antenna.

17. The calibration method of claim 12, further comprising:
transmitting the calibrated signals to a receiving end through the antennas.
